(19) United States
(12) Patent Application Publication
(10) Pub. No.: US 2021/0265113 A1
(43) Pub. Date: Aug. 26, 2021

(54) FILM CAPACITOR CELL ELEMENT AND CAPACITOR

(71) Applicant: Siemens Aktiengesellschaft, Muenchen (DE)

(72) Inventors: Werner Hartmann, (US); Sergio Yamazaki, Guarulhos (BR); Jean Marc Christmann, Nuernberg (DE)

(21) Appl. No.: 17/253,837

(22) PCT Filed: Jun. 18, 2018
(86) PCT No.: PCT/EP2018/066088

§ 371 Date: Dec. 18, 2020

(51) Int. Cl. H01G 4/015; H01G 4/14; H01G 4/38; H01G 4/32

(52) U.S. Cl. CPC H01G 4/015; H01G 4/32; H01G 4/38; H01G 4/14

(57) ABSTRACT

A capacitor cell element includes a dielectric, which has a first metal coating on a first side and has a second metal coating on a second side. The first metal coating on the first side leaves free a first edge region, and the second metal coating on the second side leaves free a second edge region. The first edge region and the second edge region are disposed at opposite ends of the dielectric. A capacitor including the capacitor cell element is also provided. The capacitor cell element and the capacitor have a high volumetric energy density and at the same time are self-healing.

The invention relates to a capacitor cell element, comprising a dielectric, which has a first metal coating on a first side and has a second metal coating on a second side, wherein the first metal coating on the first side leaves free a first edge region, and the second metal coating on the second side leaves free a second edge region.

The invention likewise relates to a capacitor comprising a capacitor cell element according to the invention.

Such capacitor cell elements are used in power capacitors. The word “edge region” in this case means a region which extends at an axial end of the polymer film from the edge thereof in the direction of the axial center thereof. This region is left free by the first metal coating or the second metal coating, i.e. it does not have this metal coating.

Power capacitors for current quality management in medium-voltage and high-voltage power supply systems have been used for many years. They were originally produced from a stack of a thin paper ply (kraft paper) as dielectric, which is located between a pair of thin metal foils which are used as capacitor electrodes.

Nowadays, use is generally made of thin aluminum foils (4 to 6 μm) and thin (a few tens of micrometers) polymer films as dielectric. In both cases, owing to the weak dielectric strength of air, the electrode-dielectric stack needs to be impregnated with an insulating oil or a comparable insulating fluid. Over the last 50 years, the size of capacitors has been reduced by 15 times, which is due to the development of polypropylene (PP) films as a high-strength dielectric and suitable liquids (oils) having a high dielectric strength.

Nevertheless, the empty space between films, films and foils and the foil itself uses spaces which do not make any contribution to the capacitance of the capacitor. Power capacitors for relatively highly rated voltages typically use two or three plies of polymer films owing to weak points in the films. In order to provide the capacitor with electrodes with which contact can be made from the outside, the metal foils and the polymer films are typically stacked and wound together in order to form a “capacitor cell”. In order not to short-circuit the individual capacitor plies, additional polymer insulating plies need to be used between the windings in order to insulate the electrode foils from one another. This design results in high levels of peak current capacity and low internal resistance, but has the disadvantage of a rather low specific energy density. If the insulator furthermore fails at any point in the capacitor cell, the cell is short-circuited, and it is necessary to use an external fuse in order to isolate the failed cells from the rest of the installation. It is therefore necessary to reduce the volume used by the dielectrics and metal foils and to select a suitable strategy for preventing catastrophic failure owing to local failures of the dielectrics.

In order to overcome these disadvantages, films which are metal-coated on one side are often used in order to produce capacitors with higher capacitances owing to the fact that there is no more empty space between the foil and the film (on one side) and the metal electrode can be reduced to a thickness of typically 20 to 50 nm. Owing to this very thin aluminum ply, this is referred to as a “self-healing capacitor”, which means that it recovers from a failure at a single point by means of removal of the aluminum close to the point owing to vaporization within a tiny arc event.

The polymer films which are metal-coated on one side are generally metal-coated from one edge almost up to the other edge; the remaining non-metal-coated rim along the other edge is used for the insulation between the metal-coated ply (electrode) and the other edge. A second, identical film is wound together with the first film in such a way that the metal-coated part makes contact with the insulator surface, and the rim points in the direction of the other side. Therefore, the metal-coated parts extend to different front sides, where they can be metal-coated (shoopage) and brought into contact in order to form a capacitor cell element.

In various embodiments, a thin polymer film is used which is metal-coated on both sides from edge to edge and is used as an electrode. The dielectric is then another thin plastic film, which is wound together with the film which is metal-coated on two sides.

The contact is likewise made by means of shoopage on both sides. Various combinations of films metal-coated on one or two sides are then used in combination with lateral segmentation of the metal-coated ply or plies in order to achieve higher voltage values than is possible with single-film designs.

The object therefore consists in providing a capacitor cell element or a capacitor which has a high volumetric energy density and is at the same time self-healing.

In accordance with the invention, a capacitor cell element is provided in which the first edge region and the second edge region are arranged at opposite ends of the dielectric.

In this capacitor cell element, the dielectric, which has the first metal coating on the first side and has the second metal coating on the second side, is provided, wherein the first metal coating on the first side leaves free the first edge region, and the second metal coating on the second side leaves free the second edge region. The opposite ends are arranged in a longitudinal direction of the dielectric.

This embodiment has the advantage that it does not have any superfluous space which would need to be filled with an insulating fluid in order to avoid weak points, as may occur in conventional non-metal-coated film-foil designs. This embodiment has the highest possible volumetric energy density which can be achieved with available materials. It is furthermore self-healing since the metal coating is thin.

It is advantageous here that an area of the first edge region corresponds to an area of the second edge region. Thus, identical component parts can be used for the first metal coating and the second metal coating. It is not necessary to manufacture or produce the first metal coating and the second metal coating separately in each case.

In accordance with the invention, it is further advantageous that the second metal coating leaves free a third edge region. This embodiment again has the advantage that it does not have any superfluous space which needs to be filled with an insulating fluid in order to avoid weak points, as may occur in conventional non-metal-coated film-foil designs. Again a highest possible volumetric energy density which can be achieved with available materials is achieved. The embodiment is furthermore self-healing since the metal coating is thin. In this embodiment, a high voltage drop can likewise be achieved. A restriction of the voltage drop is in this case not provided owing to the use of two films metal-coated on two sides.

In this case, it is also advantageous that the first metal coating leaves free a fourth edge region. This embodiment has the advantage that it does not have any superfluous space which needs to be filled with an insulating fluid in order to avoid weak points, as may occur in conventional non-metal-coated film-foil designs. This embodiment has the highest possible volumetric energy density which can be achieved with available materials. It is furthermore self-healing since the metal coating is thin.

In this case, it is advantageous that the first edge region is opposite the third edge region, and the second edge region is opposite the fourth edge region. It is thus possible for identical component parts to be used for the first metal coating and for the second metal coating. It is not necessary to manufacture or produce the first metal coating and the second metal coating separately in each case. The production of the capacitor cell element is possible in a simple and inexpensive manner.

It is also preferred that an area of the first edge region corresponds to an area of the third edge region and/or an area of the second edge region corresponds to an area of the fourth edge region. It is thus possible for identical component parts to be used for the first metal coating and for the second metal coating. It is not necessary to manufacture or produce the first metal coating and the second metal coating separately in each case. The production of the capacitor cell element is possible in a simple and inexpensive manner.

In the case of all of these embodiments, it is advantageous that the first metal coating and/or the second metal coating is or are in the form of a metal film or a metal foil, and the dielectric is in the form of a polymer film.

It is possible for the component parts conventionally used in capacitor cell elements having the abovementioned advantages to be used. It is not necessary for these component parts to be redesigned.

The invention also relates to a capacitor comprising at least two capacitor cell elements, wherein the two capacitor cell elements are arranged next to one another in such a way that adjacent edge regions overlap one another.

This arrangement is possible for all of the abovementioned capacitor cell elements. A capacitor with a high volumetric energy density and a high voltage capacity is provided. In this case, the self-healing property of the first metal coating and/or the second metal coating is maintained at the same time.

In this case, it is preferred that a contact metal foil for making contact between the two capacitor cells is arranged between the two capacitor cells. The contact metal foil results in an increased peak current capacity. This is due to its low resistance.

The above-described properties, features and advantages of this invention and the way in which they are achieved will become clearer and more readily understandable in connection with the description below of the exemplary embodiments, which are explained in more detail in connection with the drawings, in which:

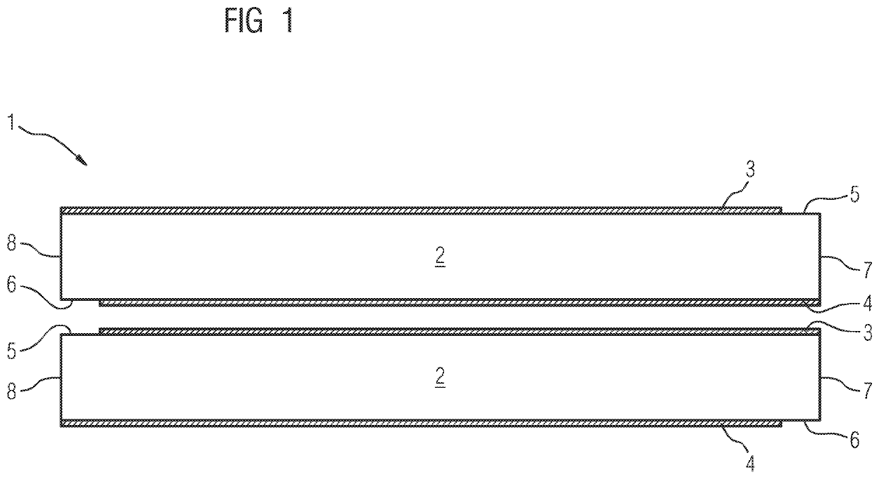

FIG. 1 shows a schematic illustration of a detail of a capacitor comprising two capacitor cell elements in accordance with a first embodiment; and

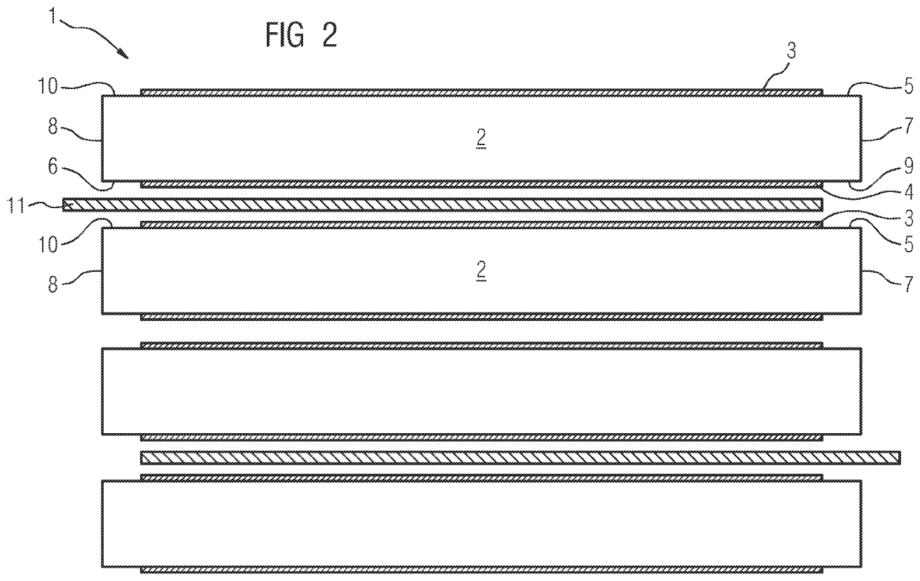

FIG. 2 shows a schematic illustration of a detail of a capacitor comprising four capacitor cell elements in accordance with a second embodiment.

FIG. 1 shows a schematic illustration of a capacitor comprising a capacitor cell element 1 in accordance with a first embodiment of the invention. The capacitor cell element 1 in this case has a dielectric 2. The dielectric 2 can be in the form of a polymer film. The dielectric 2 has a first metal coating 3 on a first side and a second metal coating 4 on a second side.

In this case, the first metal coating 3 leaves free a first edge region 5. The second metal coating 4 leaves free a second edge region 6. The first edge region 5 is arranged at a first longitudinal end 7 of the dielectric 2. The second edge region 6 is arranged at a second longitudinal end 8 of the dielectric 2. The first edge region 5 and the second edge region 6 denote regions on the dielectric 2 which are not covered by the first metal coating 3 and the second metal coating 4, respectively. These regions extend from the first longitudinal end 7 and the second longitudinal end 8, respectively, in the direction of a center of the dielectric 2.

The first edge region 5 is in this case arranged on the first side of the dielectric 2, and the second edge region 6 is arranged on the second side of the dielectric 2. Furthermore, the first edge region 5 and the second edge region 6 are arranged at the opposite longitudinal ends 7, 8 of the dielectric 2.

This embodiment has the advantage that it does not have any superfluous space which would need to be filled with an insulating fluid in order to avoid weak points, as may occur in conventional non-metal-coated film-foil designs. This embodiment has the highest possible volumetric energy density which can be achieved with available materials. It is furthermore self-healing since the first metal coating 3 and/or the second metal coating 4 is or are thin.

In the capacitor illustrated schematically in FIG. 1, two capacitor cell elements 1 are illustrated. These two capacitor cell elements 1 are arranged adjacent to one another. The arrangement is in this case designed in such a way that a first edge region 5 is arranged adjacent to a second edge region 6 at the second longitudinal end 8.

FIG. 2 shows a schematic illustration of a capacitor comprising the capacitor cell element 1 in accordance with a second embodiment. Identical reference symbols herein denote in principle the same technical features.

In the embodiment shown in FIG. 2, the first metal coating 3 leaves free a first edge region 5 on the first side of the dielectric 2, which is opposite a third edge region 9 on the second side of the dielectric 2. The third edge region 9 is left free by the second metal coating 4. Likewise, the first metal coating 3 leaves free a fourth edge region 10 on the first side of the dielectric 2, which is opposite the second edge region 6 on the second side. The fourth edge region 10 is left free by the first metal coating 3. The first edge region 5 is opposite the third edge region 9, and the second edge region 6 is opposite the fourth edge region 10.

This embodiment has the advantage that it does not have any superfluous space which needs to be filled with an insulating fluid in order to avoid weak points, as may occur in conventional non-metal-coated film-foil designs. This embodiment has the highest possible volumetric energy density which can be achieved with available materials. It is furthermore self-healing since the first metal coating 3 and/or the second metal coating 4 is or are thin.

A contact metal foil 11 is arranged between two capacitor cell elements 1. This foil serves to make contact between the capacitor cell elements 1. It can be formed from a thin metal foil. The contact metal foil 11 results in an increased peak current capacity. This is due to its low resistance.

In the capacitor illustrated schematically in FIG. 2, four capacitor cell elements 1 are illustrated. These capacitor cell elements 1 are arranged adjacent to one another. In this case, the arrangement is designed in such a way that a first edge region 5 is arranged adjacent to a third edge region 9 at the first longitudinal end 7. A second edge region 6 is formed adjacent to a fourth edge region 10 at the second longitudinal end 8.

Although the invention has been illustrated and described in more detail by preferred exemplary embodiments, the invention is not restricted by the disclosed examples, and other variations can be derived herefrom by a person skilled in the art without departing from the scope of protection of the invention.

### LIST OF REFERENCE SYMBOLS

1 capacitor cell element
2 dielectric
3 first metal coating
4 second metal coating
5 first edge region
6 second edge region
7 first end
8 second end
9 third edge region
10 fourth edge region
11 contact metal foil

1-9. (canceled)

10. A capacitor cell element, comprising:
a dielectric having opposite ends, first and second sides, a first metal coating on said first side and a second metal coating on said second side;
said first metal coating leaving a first edge region free of metal coating on said first side; and
said second metal coating leaving a second edge region free of metal coating on said second side; and
said first edge region and said second edge region each being disposed at a respective one of said opposite ends of said dielectric.

11. The capacitor cell element according to claim 10, wherein said first and second edge regions have areas corresponding to one another.

12. The capacitor cell element according to claim 10, wherein said second metal coating leaves a third edge region free of metal coating.

13. The capacitor cell element according to claim 12, wherein said first metal coating leaves a fourth edge region free of metal coating.

14. The capacitor cell element according to claim 13, wherein said first edge region is disposed opposite said third edge region, and said second edge region is disposed opposite said fourth edge region.

15. The capacitor cell element according to claim 13, wherein said first and third edge regions have areas corresponding to one another, and said second and fourth edge regions have areas corresponding to one another.

16. The capacitor cell element according to claim 13, wherein said first and third edge regions have areas corresponding to one another, or said second and fourth edge regions have areas corresponding to one another.

17. The capacitor cell element according to claim 10, which further comprises at least one of said first or second metal coatings being a metal film or a metal foil, and said dielectric being a polymer film.

18. A capacitor, comprising:
at least two capacitor cell elements according to claim 10;
said at least two capacitor cell elements being disposed next to one another; and
said edge regions of said at least two capacitor cell elements including adjacent edge regions overlapping one another.

19. The capacitor according to claim 18, which further comprises a contact metal foil disposed between two of said capacitor cell elements for making contact between said two of said capacitor cell elements.
